(19) United States
(12) Patent Application Publication
(10) Pub. No.: US 2014/0289371 A1
(43) Pub. Date: Sep. 25, 2014

(54) DEVICE, METHOD AND SYSTEM FOR MEDIA DISTRIBUTION

(71) Applicants: Sony Europe Limited, Weybridge (GB); Sony Corporation, Minato-ku (JP)

(72) Inventor: Nigel Stuart Moore, Berkshire (GB)

(73) Assignees: Sony Europe Limited, Weybridge (GB); Sony Corporation, Minato-ku (JP)

(21) Appl. No.: 14/203,712

(22) Filed: Mar. 11, 2014

(30) Foreign Application Priority Data
Mar. 25, 2013 (GB) 1305407.7

(51) Int. Cl. H04L 29/06

(52) U.S. Cl. CPC H04L 65/60
USPC 709/219

(57) ABSTRACT

A media distribution system comprises a client device and a server device connected by a data link, in which the server device is operable to provide respective versions of successive contiguous segments of a media presentation, each segment being encoded as at least two versions at different respective data rates and the client device is operable to request, from the server device, a version of each successive segment so as to stream the media presentation from the server device to the client device; the server device being configured to provide a data file to the client device defining the available versions of the segments according to their respective data rates and an indication of their respective encoding quality; and the client device being configured to select, in respect of a segment of the media presentation, a version having a data rate which does not exceed the data capacity of the data link and which has the highest indication of encoding quality.

### BACKGROUND

1. Field of the Disclosure

This disclosure relates to media distribution.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

The so-called MPEG DASH (Dynamic Adaptive Streaming over Http) standard, defined in ISO/IEC 23009-1, aims to address issues which can arise when video is streamed over an http link. In basic terms, the technique attempts to balance the general requirement to obtain the greatest possible streaming video quality over a certain data link, against the fact that typical link qualities (data transfer rate, error rate and the like) and the data handling capacity of the recipient decoder can vary, sometimes in an unpredictable way.

DASH addresses this problem by partitioning the video to be streamed into consecutive time segments of perhaps a few seconds to a few tens of seconds in length. Each time segment is encoded as multiple “adaptation sets” that provide the respective video and audio content corresponding to that time segment. So, for example, there might be a video adaptation set, a separate audio adaptation set and a separate subtitling data adaptation set. Within an adaptation set, multiple representations of the content are provided, but at different respective qualities and corresponding encoded data rates.

In DASH, the selection of which representation to stream for a particular time segment is under the control of a controller responsive to the link and/or the recipient decoder performance. In general, the highest encoded data rate representation which is consistent with the available link and recipient decoder performance is selected. If the system performance improves during streaming of a representation corresponding to a particular time segment, then a higher encoded data rate representation can be selected for the next time segment. If the system performance deteriorates during streaming of a segment, or if the transmission system simply cannot cope in a sustainable way with the encoded data rate of the representation in use, then a lower encoded data rate representation can be used for the next time segment, and so on.

Detection of whether the link performance is adequate can be by detecting the occupancy of a data buffer at the receiver, for example. The aim is to keep the buffer partially populated, for example with data corresponding to a certain time period of the replayed media. Here, it is noted that data is introduced to the buffer at the streamed data rate, but data is read from the buffer at the encoded data rate dependent upon the timing associated with the reproduction of the media. So, for example, if the current streaming data is encoded in such a way as to provide (say) 100 kB (kilobytes) of data corresponding to 1 second of reproduced content, then the data will be read from the buffer at the encoded data rate of 100 kB/s, but the data will enter the buffer at a streamed (transmission) rate dependent upon other factors including the transmission capacity of the link between the server and the recipient client device. As mentioned, the target is to keep the buffer partially occupied, so as to provide enough buffered data to cope with temporary network fluctuations or delays. If the buffer occupancy is too low, particularly if at any time the buffer contains too little data to decode the next required picture, then this can result in interruptions in the reproduced content. It is apparent in such circumstances that the link performance is inadequate for the currently selected representation, and a lower data rate representation is selected for the next time segment. A buffer occupancy that is too high can lead to data being discarded and re-requested (which is wasteful of network bandwidth) and can also indicate that the media being streamed has too low an encoded data rate—which would generally indicate that the user is being presented with inferior media compared to the media which the network link would support.

The control algorithm is generally carried out at the decoder (data receiver) side, by the decoder requesting the appropriate representation to be sent by the data source. In order for the decoder to know which representations are available, the first item to be downloaded in a DASH streaming session is a so-called manifest file, also known as a Media Presentation Description. This XML format file identifies the various content components (each corresponding to an adaptation set) and the representations available within each adaptation set.

### SUMMARY

This disclosure provides a media distribution system comprising a client device and a server device connected by a data link, in which the server device is operable to provide respective versions of successive contiguous segments of a media presentation, each segment being encoded as at least two versions at different respective data rates and the client device is operable to request, from the server device, a version of each successive segment so as to stream the media presentation from the server device to the client device;

the server device being configured to provide a data file to the client device defining the available versions of the segments according to their respective data rates and an indication of their respective encoding quality; and

the client device being configured to select, in respect of a segment of the media presentation, a version having a data rate which does not exceed the data capacity of the data link and which has the highest indication of encoding quality.

Further respective aspects and features of the disclosure are defined in the appended claims.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

Embodiments of the present technology will now be described, by way of example only, with reference to the accompanying drawings in which:

FIG. 1 schematically illustrates a media distribution network;

FIG. 2 schematically illustrates the communication between a media distribution server and a recipient client device;

FIG. 3 schematically illustrates successive media segments;

FIG. 4 schematically illustrates a streaming controller and a media decoder;

FIG. 5 schematically illustrates a streaming controller;

FIG. 6 schematically illustrates a media network; and

FIGS. 7 to 9 are schematic flowcharts illustrating methods associated with embodiments of the present disclosure.

### DETAILED DESCRIPTION OF THE EMBODIMENTS

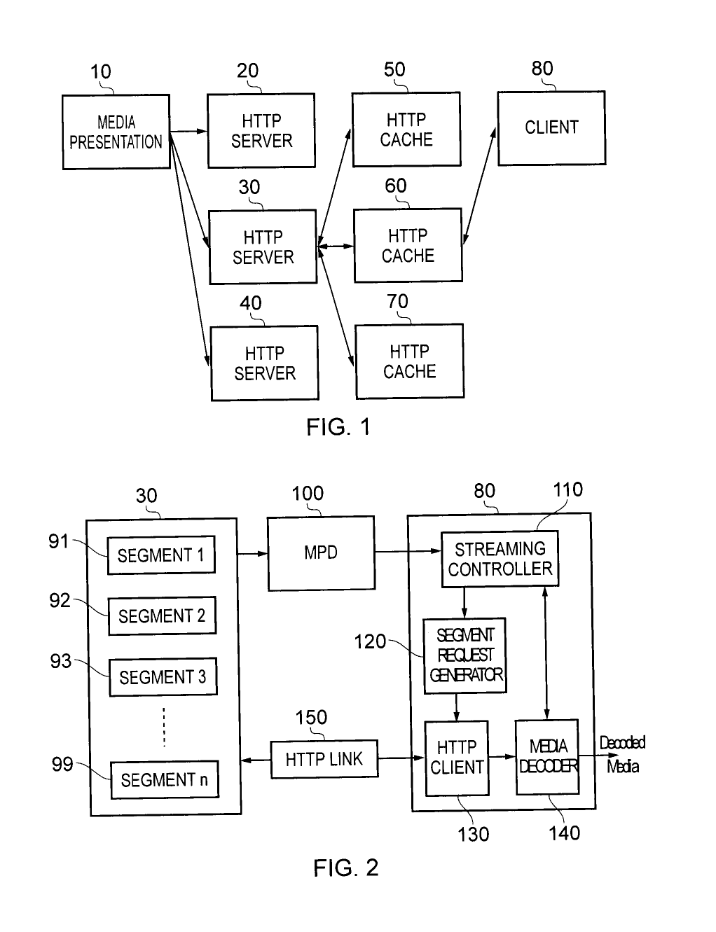

Referring now to the drawings, FIG. 1 schematically illustrates a media distribution network relating to a media presentation 10 which may be in the form of a stored presentation or a live media event. Here, the term “media” refers (by way of example) to an audio and video presentation, possibly with additional data such as subtitling or alternative language audio tracks. More generally, the “media” could be just audio data, just video data, audio and video data or any of these with additional types of data also being provided. The reference to video data could be in respect of video content captured by one or more cameras, video content generated by computer, or combinations of these. The media presentation 10 may be stored on a server, for example.

The media presentation 10 is passed to one or more HTTP servers 20, 30, 40. In the example of FIG. 1, three such servers are illustrated, but the basic requirement is for one or more such servers. Data transmission from an example HTTP server 30 is shown, via one or more HTTP caches 50, 60, 70 to a client device 80.

Accordingly, the system of FIG. 1 provides an arrangement for streaming media data relating to the media presentation 10 to the client device 80. Here, the term “streaming” generally refers to the transmission of media to the client device 80, in such a way that the media is presented to the user while it is being transferred. So, media streaming contrasts with a “downloading” process in which a media file is first downloaded and then (once downloaded) presented to the user. Clearly the division between these two systems is not an absolute one: there can be a degree of overlap in the definitions because a user could start to replay a downloaded media file part way through the downloading process, and a streamed media transmission will normally be buffered (perhaps just temporarily) at the recipient device. But in the present context, a significant feature of the streamed media transmission is that the properties of the media being streamed can be adapted based upon the transmission and/or handling of the streamed media data.

The transmission of the media data to the client device 80 is via HTTP (Hypertext transfer protocol). HTTP, of itself, is a known technique which operates using a request-response model, so that the transfer of a portion of data from the HTTP server 30 to the client device 80 is initiated by the client device 80 making a request for that data portion, and the HTTP server responding to that request by transmitting the required data portion.

The HTTP caches 50, 60, 70 are normal features of an HTTP data distribution arrangement, but may be considered as optional in respect of the fundamental features of the present technology. That is to say, the important aspects of the HTTP transmission of the media presentation 10 are the HTTP server (such as the HTTP server 30) and the recipient client device (such as the client device 80), which are associated with one another by a data network connection so that the client device can request data portion is to be transmitted from the HTTP server to the client device, and the HTTP server is arranged to respond to such requests by transmitting the requested data portion.

Accordingly, the arrangement of FIG. 1 provides an example of a media distribution system comprising client device circuitry and server device circuitry connected by a data link.

FIG. 2 schematically illustrates the communication between a media distribution server (such as the HTTP server 30 of FIG. 1) and a recipient client device (such as the client device 80 of FIG. 1).

As mentioned above, the DASH technique partitions the media to be streamed into consecutive time segments of perhaps a few seconds to a few tens of seconds in length. Each time segment is encoded as multiple “adaptation sets” that provide the respective video, audio and any other content corresponding to that time segment. So, for example, there might be a video adaptation set, a separate audio adaptation set and a separate subtitling data adaptation set. In other embodiments adaptation sets may contain any combination of audio, video, subtitle or language content.

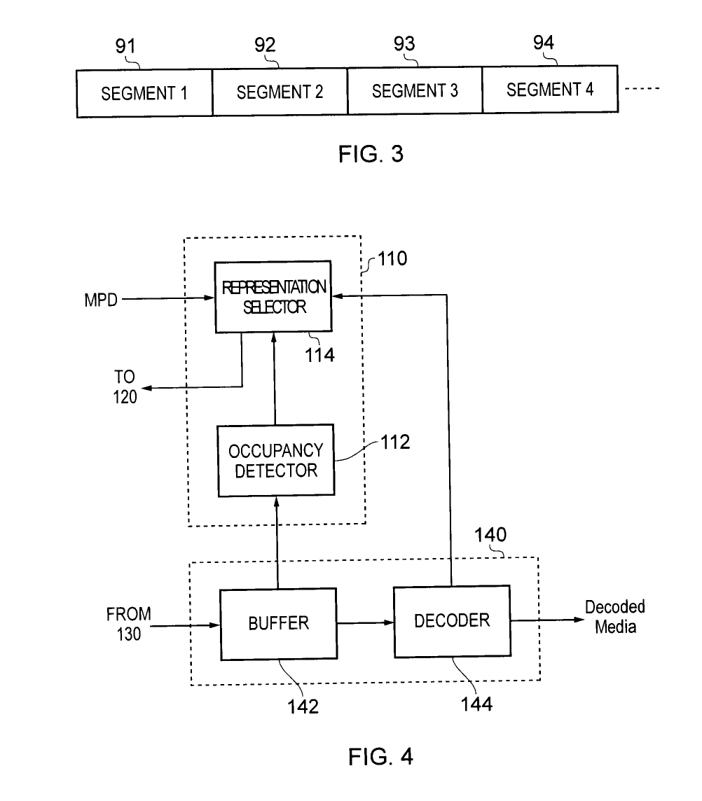

In FIG. 2, the server 30 is shown as storing the adaptation sets. For clarity of the diagram, segments 91, 92, 93, 94 of a single one of the adaptation sets are illustrated, but it will be understood that corresponding segments of the other adaptation sets are also provided at the server 30. The time segmentation is the same for each of the adaptation sets, although in other embodiments different time segmentation could be used between the various adaptation sets. The segments shown in FIG. 2 include first 91, second 92 and third 93 segments, and an nth segment 99. Referring to FIG. 3, the segments are contiguous in time, so that the first segment 91 is followed immediately by the second segment 92, which is followed immediately by the third segments 93, which is followed immediately by a fourth segment 94 and so on. Note that the segments are encoded independently so as to allow the system to change from a particular segment of one representation to a next segment from another representation. Therefore, there is no inter-picture encoding dependency between one segment and a next segment.

Within an adaptation set, multiple representations of the content are provided, but at different respective qualities and corresponding encoded data rates. In basic terms, this means that for any time period represented by a segment, there is a choice of two or more versions or representations of the media relating to that segment, such that the two or more versions have different encoded data rates.

In a real system, many more than two options may be provided. In embodiments of the technology, the client device 80 is able to select a version (and a corresponding encoded data rate) to use in respect of each time period corresponding to a segment.

In order to make this selection, the client device 80 requires information defining the availability of different versions of each segment. This information is provided in a data file called a “manifest” or, more formally, a “Media Presentation Description” (MPD) file 100 which is passed from the HTTP server 30 to the client device 80 as a first stage of streaming a particular media presentation 10 to the client device. In common with other aspects of the HTTP transmission, the MPD file 100 is requested by the client device 80 and the server 30 response to such a request by transmitting the MPD file 100 to the client device 80.

The MPD file 100 defines the various versions of each adaptation set which are available for transfer to the client device 80. An MPD file can contain a significant amount of information, so a schematic example of a full MPD file will first be provided, and then a reduced version of the MPD file showing just the information relating to a video adaptation set will then be provided.

The following is a schematic example MPD file for a system using the so-called H.264 MPEG-4

AVC (advanced video coding) encoding technique. The MPD file is expressed as an extensible mark-up language (XML) text file with various XML fields providing different aspects of the information needed by the client device 80. In the example below, details are provided for addresses to be accessed in order to obtain the media presentation (“BaseURL”) and for respective adaptation sets relating to English language audio tracks (“English Audio”), French language audio tracks (“French Audio”), subtitling data (“Timed Text”) and video data (“Video”).

<MPD>
<BaseURL>http://cdn1.example.com/</BaseURL>
<BaseURL>http://cdn2.example.com/</BaseURL>
<Period>
<!-- English Audio -->
<AdaptationSet mimeType=“audio/mp4” codecs=“mp4a.0x40” lang=“en”
subsegmentAlignment=“true” subsegmentStartsWithSAP=“1”> <ContentProtection
schemeIduri=“urn:uuid:706D6953-656C-5244-4D48-656164657221”/> <Representation id=“1”
bandwidth=“64000”> <BaseURL>7657412348.mp4</BaseURL> </Representation> <Representation
id=“2” bandwidth=“32000”> <BaseURL>3463646346.mp4</BaseURL> </Representation>
</AdaptationSet>
<!-- French Audio -->
<AdaptationSet mimeType=“audio/mp4” codecs=“mp4a.40.2” lang=“fr”
subsegmentAlignment=“true” subsegmentStartsWithSAP=“1”> <ContentProtection
schemeIdUri=“urn:uuid:706D6953-656C-5244-4D48-656164657221”/> <Role
schemeIduri=“urn:mpeg: dash: role” value=“dub”/> <Representation id=“3”
bandwidth=“64000”> <BaseURL>3463275477.mp4</BaseURL> </Representation> <Representation
id=“4” bandwidth=“32000”> <BaseURL>5685763463.mp4</BaseURL> </Representation>
</AdaptationSet>
<!-- Timed text -->
<AdaptationSet mimeType=“application/ttml+xml” lang=“de”> <Role
schemeIdUri=“urn:mpeg:dash:role” value=“subtitle”/> <Representation id=“5”
bandwidth=“256”> <BaseURL>796735657.xml</BaseURL> </Representation> </AdaptationSet>
<!-- Video -->
<AdaptationSet mimeType=“video/mp4” codecs=“avc1.4d0228” subsegmentAlignment=“true”
subsegmentstartsWithSAP=“2”>
<ContentProtection schemeIdUri=“urn:uuid:706D6953-656C-5244-4D48-656164657221”/>
<Representation id=“6” bandwidth=“256000” width=“320” height=“240”>
<BaseURL>8563456473.mp4</BaseURL> </Representation>
<Representation id=“7” bandwidth=“512000” width=“320” height=“240”>
<BaseURL>56363634.mp4</BaseURL> </Representation>
<Representation id=“8” bandwidth=“1024000” width=“640” height=“480”>
<BaseURL>562465736.mp4</BaseURL> </Representation>
<Representation id=“9” bandwidth=“1384000” width=“640” height=“480”>
<BaseURL>41325645.mp4</BaseURL> </Representation>
<Representation id=“A” bandwidth=“1536000” width=“1280” height=“720”>
<BaseURL>89045625.mp4</BaseURL> </Representation>
<Representation id=“B” bandwidth=“2048000” width=“1280” height=“720”>
<BaseURL>23536745734.mp4</BaseURL>
</Representation>
</AdaptationSet>
</Period>
</MPD>

To make the discussion of the MPD file 100 a little clearer, the following information is taken from the representation shown above, but relates only to properties of the different versions of the video data available within the video adaptation set. Here, it can be seen that the adaptation set defines a video format by defining an overall video type (“video/mp4”) and a specification of a particular codec (coder-decoder) (“avc1.4d0228”).

<!-- Video -->
<AdaptationSet mimeType=“video/mp4” codecs=“avc1.4d0228”>

<Representation id=“6” bandwidth=“256000” width=“320”
height=“240”/>
<Representation id=“7” bandwidth=“512000” width=“320”
height=“240”/>
<Representation id=“8” bandwidth=“1024000” width=“640”
height=“480”/>
<Representation id=“9” bandwidth=“1384000” width=“640”
height=“480”/>
<Representation id=“A” bandwidth=“1536000” width=“1280”
height=“720”/>
<Representation id=“B” bandwidth=“2048000” width=“1280”
height=“720”/>

</AdaptationSet>

The MPD file defines, for the video adaptation set, the following data rates in order of ‘quality’:

| Representation ID | Bandwidth | Codec | (Quality) |
|---|---|---|---|
| 6 | 256000 | AVC | 1 |
| 7 | 512000 | AVC | 2 |
| 8 | 1024000 | AVC | 3 |
| 9 | 1384000 | AVC | 4 (high quality SD) |
| A | 1536000 | AVC | 5 (720 low) |
| B | 2048000 | AVC | 6 (720 high) |

Here, the “representation ID” is simply an identification number to allow for easy communication between the client device and the server, so that the client device can specify a version of the video data simply by quoting the representation ID in its request for data. The bandwidth is expressed in data bits per second. The codec in this example is the same (AVC) for all of the versions. The width and height expressed in the MPD file relates to the pixel width and pixel height of the particular version when decoded.

The column labelled as “quality” in the above table does not appear in the MPD file. This is included to give an indication of the expected ordering of subjective or encoding quality between the different representations, with a lower number indicating a lower subjective quality and a higher number indicating a higher subjective quality. Further labels have been provided in that the representation having the ID 9 corresponds to a high quality standard definition (SD) representation; the representation having the ID A corresponds to a low quality 720 line high-definition (HD) representation; and the representation having the ID B corresponds to a higher quality 720 line HD representation.

It can be seen in this example that the subjective video quality changes monotonically with the data rate of the representations. So, a higher data rate provides a higher subjective video quality. Part of the reason why this is true in the example given above is that the same codec is used between the different representations (they all use an AVC codec).

The operation of the apparatus of FIG. 2 will first be described in connection with the example MPD file already discussed, that is to say, and MPD file in which the subjective video quality changes monotonically with the data rate. Then, an arrangement according to embodiments of the present technology will be discussed, in which the subjective video quality does not change monotonically with the data rate.

So, returning to FIG. 2, the MPD file 100 is supplied to the client device 80 which comprises a streaming controller 110, a segment request generator 120, an HTTP client 130 and a media decoder 140. The MPD file 100 is itself stored and handled by the streaming controller 110. In embodiments, the MPD file is supplied to the client device before the client device starts to stream the media data.

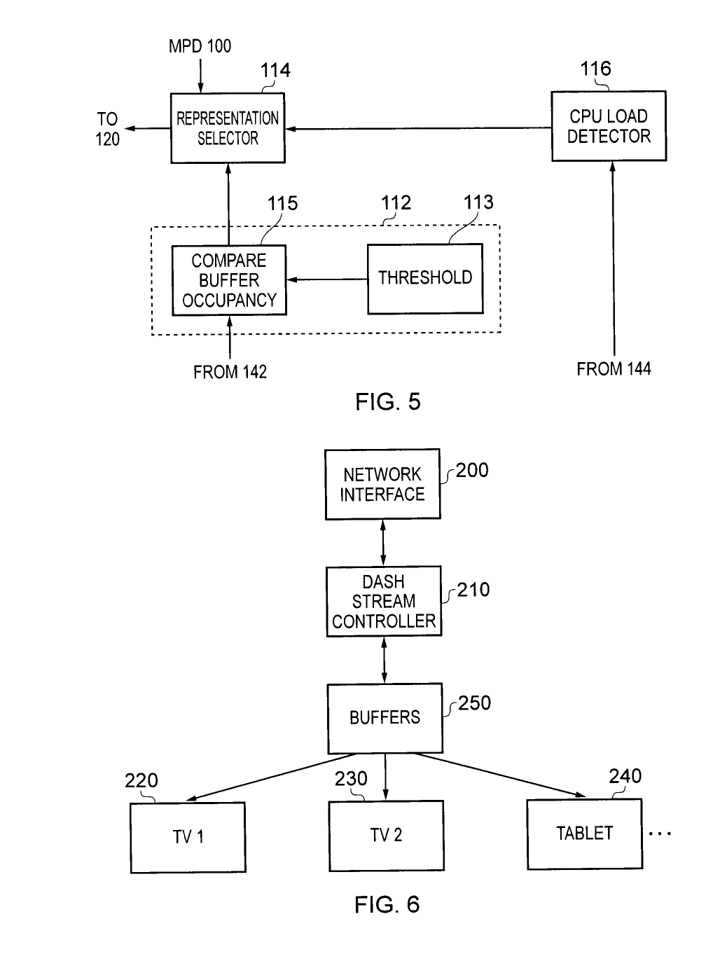

In operation, the streaming controller 110 selects, from time to time, a representation from within the multiple representations contained in an adaptation set. It does this in response to factors indicating the way that the received data is being received and/or handled at the client device. Such factors may include the occupancy of a data buffer at the media decoder 140 and/or the ability of the media decoder 140 to cope with the processing requirements of the received data. The way in which these factors are taken into account will be discussed below with reference to FIGS. 4 and 5. The streaming controller 110 indicates a required representation to the segment request generator 120 which in turn generates requests for the success of segments 91 . . . 99 of the adaptation set. These requests are provided to the HTTP client 130 which generates and deals with specific HTTP requests for data portions from the server 30, via a network connection illustrated generically as an HTTP link 150. Note that the HTTP link may include various network connections and may also include one or more HTTP caches as described with reference to FIG. 1.

At a basic level, if the buffer occupancy and/or the processor load detected by the streaming controller 110 indicate that either the HTTP link 150 or the media decoder 140 (or indeed both) is or are unable to handle the data rate of the currently selected representation, the streaming control 110 is operable to change to a lower data rate representation. Ideally, this is done in a progressive way so that the changes in subjective quality, as perceived by the user, are subtle rather than the user experiencing dramatic quality changes at a segment boundary. On the other hand, if the buffer occupancy and the processor loading is detected by the streaming controller 110 indicates that the link and the media decoder are well able to handle the current data rate, the streaming controller may elect to attempt a next-higher data rate representation so as to provide an improved subjective quality to the user. Again, this is handled by indicating to the segment request generator 120 that a next-higher data rate representation should be selected, with the segment request generator 120 then instructing the HTTP client 130 to make the HTTP requests for the appropriate data portions from the server 30.

In normal operation, the changes from one representation to another are steady and subtle. Of course, extreme situations may arise. For example, if there is a sudden step change in the capacity of the HTTP link 150, it may be that the media decoder 140 runs out of data and so has to pause the decoding process. In such circumstances, rather than simply reloading or waiting for data at the currently selected data rate, the streaming controller 110 may elect to implement a large step change in the data rate of the required representation so as to allow the repopulation of the data buffer at the media decoder 140 to be performed more quickly.

Note that the video adaptation set generally has a very much higher data rate than any other adaptation set, so changes to the video data rate from one video representation to another video representation will have a much larger influence on the system, in terms of a detection of whether the HTTP link 150 and the media decoder 140 are coping with a current data rate, than changes to other adaptation sets such as a selected audio channel or subtitling data. So, it may be that the streaming controller 110 changes from one representation to another representation in respect of the video adaptation set but makes no change to the selected representation within the audio adaptation set (if indeed multiple representations are provided). Or alternatively, it may be that the streaming controller 110 is able to change from one audio representation to another audio representation, but this happens less frequently than changes from one video representation to another video representation.

Note also that the streaming controller 110 is arranged to select those adaptation sets which are relevant to the user's needs in respect of reproducing the media presentation 10. So, if the user require subtitles, the user may indicate this (by a user control, not shown) to the streaming controller 110 which will then select the appropriate subtitling adaptation set. If the user does not indicate a requirement for subtitles, the streaming controller 110 does not select a subtitling adaptation set. Similarly, the streaming controller 110 would normally select only one audio adaptation set in respect of a language selected by the user for that media presentation or as a default language setting.

Accordingly, in respect of the discussion above, the server 30 is an example of server device circuitry configured to provide respective versions of successive contiguous segments of a media presentation, each segment being encoded as at least two versions at different respective data rates and the client device 80 is an example of client device circuitry configured to request, from the server device circuitry, a version of each successive segment so as to stream the media presentation from the server device circuitry to the client device circuitry.

The MPD file 100 is an example of a data file provided to the client device circuitry defining the available versions of the segments according to their respective data rates and an indication of their respective encoding quality. In the above description, the client device circuitry is configured to select, in respect of a segment of the media presentation, a version having a data rate which does not exceed the data capacity of the data link and which has the highest indication of encoding quality.

The server 30 is also an example of media distribution server device circuitry connectable by a data link to client device circuitry, in which the server device circuitry is operable to provide respective versions of successive contiguous segments of a media presentation, each segment being encoded as at least two versions at different respective data rates and a data file to the client device circuitry defining the available versions of the segments according to their respective data rates and an indication of their respective encoding quality.

The client 80 is also an example of media distribution client device circuitry connectable to server device circuitry by a data link to receive, from the server device circuitry, respective versions of successive contiguous segments of a media presentation, each segment being encoded as at least two versions at different respective data rates and a data file to the client device circuitry defining the available versions of the segments according to their respective data rates and an indication of their respective encoding quality; the client device circuitry being configured to request, from the server device circuitry, a version of each successive segment so as to stream the media presentation from the server device circuitry to the client device circuitry, the client device circuitry being configured to select, in respect of a segment of the media presentation, a version having a data rate which does not exceed the data capacity of the data link and which has the highest indication of encoding quality.

FIG. 4 schematically illustrates part of the operation of the streaming controller 110 and the media decoder 140.

The media decoder 140 comprises a buffer 142 (as an example of data buffer circuitry) and a decoder 144. The buffer 142 receives media data from the HTTP client 130 which is to say, media data requested from the server 30 according to the currently selected representations and adaptation sets specified by the streaming controller 110. The received data is stored temporarily in the buffer 142 on a first-in-first-out basis. The data enters the buffer at the received data rate but is read from the buffer at the encoded data rate. These data rates may be different. If the received data rate is greater than the encoded data rate, then the requests for data portions made by the HTTP client 130 needs to allow time for data to be read from the buffer before further data is added to the buffer. If the received data rate is lower than the encoded data rate, then the buffer will tend to empty, and in an extreme situation the decoder 144 may run out of data to be decoded.

An indication of the current buffer occupancy is supplied from the buffer 142 to an occupancy detector 112 (forming an example of a buffer occupancy detector circuitry configured to detect the occupancy of the data buffer circuitry) forming part of the streaming controller 110. The occupancy detector 112 is operable to detect whether the buffer occupancy is too low (which would prompt the streaming controller to change to a lower data rate representation) or too high (which would prompt a pause in the requesting of the next data portion by the HTTP client 130). Indications of the buffer occupancy being too low, too high or within an acceptable range are passed by the occupancy detector to a representation selector 114. The representation selector 114 has access to the MPD file 100 and also to a further signal from the decoder 144 which indicates whether or not the decoder is able to cope with the current processing load associated with the current representation's data rate.

In response to these inputs from the occupancy detector 112, the MPD file 100 and the decoder 144, the representation selector 114 the current representation is appropriate or a lower or higher data rate representation should be selected. As mentioned above, this decision can be made independently for each of the adaptation sets, and indeed some adaptation sets (such as subtitling data) may not have a choice of representations. The most significant choice is in respect of the video adaptation set. The representation selector 114 supplies a signal to the segment request generator 120 indicating any changes to the currently selected representations. Normally any changes will take effect at the next segment boundary, but in extreme circumstances such as those discussed above, a change can take place straightaway.

FIG. 5 schematically illustrates the streaming controller 110 in slightly more detail.

In terms of the occupancy detector 112, this may be implemented as a comparator 115 and a data store 113 which stores one or more threshold values in respect of buffer occupancy. In one example, the store 113 contains two threshold values, one indicating a lower acceptable occupancy limit and the other indicating an upper acceptable occupancy limit. A buffer occupancy between the two threshold values is considered to be acceptable. A buffer occupancy below the lower acceptable limit is too low (leading to the possible selection of a lower data rate representation as discussed above) and a buffer occupancy above the upper acceptable limit is considered too high (leading to a pause before the next data portion is requested) and, optionally, a possible selection of an increased data rate representation by the representation selector 114. FIG. 5 also shows a CPU load detector 116 as a schematic illustration of an arrangement for detecting a processing load of the decoder 144. Accordingly, in embodiments, the client device is configured to select a lower data rate version if the detected buffer occupancy falls below a lower occupancy limit.

So far, the discussion has been based around sets of representations within an adaptation set (particularly, though not exclusively, a video adaptation set) in which the subjective quality varies monotonically with data rate of the representations. This is normally the case in situations where the same codec is used in respect of all of the representations within an adaptation set. In the examples given above, the AVC codec was used for all of the video representations within the video adaptation set.

But consider an example in which a different codec is also used so that, for example, the versions are encoded according to a group of two or more different media encoders. For example, in the MPD file described above, further video representations encoded using the so-called HEVC (High Efficiency Video Coding) codec may be provided in addition to those encoded using the AVC codec. Reasons why two such codecs may be used include (i) the fact that HEVC represents a newer technology, and so the AVC data may need to be retained for older decoders which cannot handle the newer HEVC technology, (ii) HEVC is particularly suitable for very high quality video data (for example 1080 line HD and so-called “4K” or even “8 k” signals having respectively about twice or about four times the number of pixels of 1080 line HD signals), which AVC could not easily cope with in a manageable data rate, and (iii) the provider of the media presentation may not wish to re-encode all of the existing AVC encoded representations into a new format. In these examples, therefore, the addition of HEVC representations to the adaptation set extends the range of quality available to the user. Of course, the present techniques are not limited to AVC and HEVC, but could also be used in other mixed codec environments (which may or may not include HEVC or AVC).

However, the coding efficiency of HEVC is different to that of AVC. This is one of the reasons why HEVC might be used, because it provides a greater coding efficiency, particularly at high subjective qualities, than AVC. Here, the term “coding efficiency” is an indication of the amount of data generated for a particular subjective quality; a greater coding efficiency indicates that a particular subjective quality may be achieved at a lower encoded data rate.

This feature of the multiple codecs can introduce complications to a DASH scheme by destroying the monotonic relationship between encoded data rate and subjective video (or encoding) quality.

Consider an example of the MPD file 100 discussed above, but including additional HEVC representations. Here, the whole MPD is not reproduced (for clarity of explanation) but the tabular representation of the different video formats is reproduced with the additional HEVC signals included:

| Rep ID | Bandwidth | Codec | Quality |
|---|---|---|---|
| 6 | 256000 | AVC | 1 |
| 7 | 512000 | AVC | 2 |
| 8 | 1024000 | AVC | 3 |
| 9 | 1384000 | AVC | 4 (high quality SD) |
| A | 1536000 | AVC | 5 (720 low) |
| B | 2048000 | AVC | 6 (720 high) |
| C | 1766000 | HEVC | 7 (1080 low) |
| D | 2048000 | HEVC | 8 (1080 medium) |
| E | 3000000 | HEVC | 9 (1080 good) |
| F | 5000000 | HEVC | 10 (4K low) |
| G | 12000000 | HEVC | 11 (4K good) |
| H | 20000000 | HEVC | 12 (8K) |

Here, note that representations B and D have rather different subjective or encoding qualities, in that representation D is a 1080 line HD representation, that is to say, better than representation B which is a 720 line HD representation, but they have the same encoded data rate. Note also that representation C has a potentially higher quality than representation B but a lower encoded data rate.

In a further development, it may be that the service provider (the provider of the media presentation and/or the server 30) wishes to lower delivery (bandwidth) costs for the higher data rate streams which are encoded in AVC (for example, the representations 9, A, B), by using HEVC. The service provider recognises that they will have a cost associated with generating these extra representations, and an asset management (storage) issue for the extra representations, but (in this example) the service provider believes that the lower data delivery bandwidth and costs for HEVC enabled client devices will be worth this investment.

| Rep ID | Bandwidth | Codec | Quality |
|---|---|---|---|
| 6 | 256000 | AVC | 1 |
| 7 | 512000 | AVC | 2 |
| 8 | 1024000 | AVC | 3 |
| 9 | 1384000 | AVC | 4 (high quality SD) |
| 9′ | 800000 | HEVC | 4* |
| A | 1536000 | AVC | 5 (720 low) |
| A′ | 1280000 | HEVC | 5* |
| B | 2048000 | AVC | 6 (720 high) |
| B′ | 1460000 | HEVC | 6* |
| C | 1766000 | HEVC | 7 (1080 low) |
| D | 2048000 | HEVC | 8 (1080 medium) |
| E | 3000000 | HEVC | 9 (1080 good) |
| F | 5000000 | HEVC | 10 (4K low) |
| G | 12000000 | HEVC | 11 (4K good) |
| H | 20000000 | HEVC | 12 (8K) |

*Note that the subjective qualities indicated by the same quality indices (such as quality = 4) may not be exactly the same on an analytical basis, but for purposes of consumer comparison they are considered the same.

In these examples, because the monotonic relationship between data rate and subjective quality has been broken, following just a basic data rate selection algorithm such as the algorithm described above in respect of the streaming controller 110 may lead to an incorrect selection of representation by the streaming controller 110.

For example, if the available capacity of the HTTP link 150 is 1600000 bit/s, the best selection (based on a simple data rate-based algorithm) is representation A, 1536000 AVC. However, representations A′ and B′ are available and (in the case of B′) superior even though they are a lower bit-rate.

To address this issue, embodiments of the present technology provide the further facility (missing in previously proposed DASH systems) to allow selection of representations based on ‘quality’ as well as on the existing factors such as link capacity and/or decoder load.

Two example embodiments, to be referred to as “option 1” and “option 2” will now be discussed.

### Option 1

An “equivalent” AVC data rate flag could be used, which is called ‘eq_bw’ in the example which follows. The equivalent AVC data rate flag indicates a notional equivalent data rate which would apply to a non-AVC representation if the video were encoded to the same subjective or encoding quality but using AVC. The following portion of an MPD file provides an example of such a flag in use. In other words, in embodiments, the indication of the respective encoding quality comprises an indication of an equivalent data rate of a version if that version were encoded using a different media encoder of the group of two or more media encoders.

<!-- Video -->
<AdaptationSet mimeType=“video/mp4” codecs=“avc1.4d0228, hvc1” alt codecs>

| | |
|---|---|
| <Representation id=“6” bandwidth= “256000” width= “320” height= “240” | /> |
| <Representation id=“7” bandwidth= “512000” width= “320” height= “240” | /> |
| <Representation id=“8” bandwidth=“1024000” width= “640” height= “480” | /> |
| <Representation id=“9” bandwidth=“1384000” width= “640” height= “480” | /> |
| <Representation id=“A” bandwidth=“1536000” width=“1280” height= “720” | /> |
| <Representation id=“B” bandwidth=“2048000” width=“1280” height= “720” | /> |

<Representation id=“C” bandwidth=“1766000” width=“1920” height=“1080”

eq_bw=“3100000” codec=“hvc1”/>

<Representation id=“D” bandwidth=“2048000” width=“1920” height=“1080”

eq_bw=“4200000” codec =“hvc1”/>

<Representation id=“E” bandwidth=“3000000” width=“1920” height=“1080”

eq_bw=“6500000” codec=“hvc1”/>

<Representation id=“F” bandwidth=“5000000” width=“3840” height=“2160”

eq_bw=“9600000” codec=“hvc1”/>
</AdaptationSet>

Note that the equivalent AVC data rate flag is used, in the above example, only in respect or non-AVC encoded video data, but in other embodiments the equivalent AVC data rate flag could be provided in respect of all of the representations. Of course, in the case of AVC-encoded representations, the equivalent AVC data rate would be the same as the actual data rate.

The equivalent AVC data rate flag allows a different algorithm to be used by the streaming controller 110 to select a representation from within an adaptation set.

This algorithm involves three constraints. For an available link bandwidth of the HTTP link 150, the streaming controller 110 selects that representation which fulfills the following criteria:
the actual data rate of the representation is no higher than the available link bandwidth;
the equivalent AVC data rate (which is equal to the actual data rate for AVC-encoded data) is as high as possible; and
the decoder 140 is capable of decoding video data of that format.

If the streaming controller 110 needs to change to a lower data rate representation (for example, because the HTTP link 150 is not able to cope with the current data rate, so that the buffer 142 is becoming unacceptably depleted) then the streaming controller 110 follows the same criteria and selects the next-lower actual data rate is defined by the MPD file for which:
the equivalent AVC data rate (which is equal to the actual data rate for AVC-encoded data) is as high as possible; and
the decoder 140 is capable of decoding video data of that format.

Similarly, if the streaming controller 110 needs to change to a higher data rate representation (for example, because the HTTP link 150 is easily able to cope with the current data rate, so that the buffer 142 is becoming unacceptably full) then the streaming controller 110 follows the same criteria and selects the next-higher actual data rate is defined by the MPD file for which:
the equivalent AVC data rate (which is equal to the actual data rate for AVC-encoded data) is as high as possible; and
the decoder 140 is capable of decoding video data of that format.

Note that the discussion has referred to an equivalent AVC data rate, but the equivalent rate could refer to any of the codecs in use in respect of that MPD file. So, for example, the AVC-encoded data could be expressed in terms of an equivalent HEVC data rate (which, because of the generally higher encoding efficiency of HEVC would normally be expected to be lower than the actual AVC encoded data rate).

### Option 2

Instead of expressing data rates as the equivalent in other codec systems, a new metric of ‘intended subjective (encoding) quality’ could be used. In the example which follows, a new quality ranking attribute could be introduced to the MPD file which is called “q_r” in the following schematic fragment or section of an example MPD file:

<!-- Video -->
<AdaptationSet mimeType=“video/mp4” codecs=“avc1.4d0228, hvc1” alt codecs>

| | |
|---|---|
| <Representation id=“6” bandwidth= “256000” width= “320” height= “240” q_r=“1” | /> |
| <Representation id=“7” bandwidth= “512000” width= “320” height= “240” q_r=“2” | /> |
| <Representation id=“8” bandwidth=“1024000” width= “640” height= “480” q_r=“3” | /> |
| <Representation id=“9” bandwidth=“1384000” width= “640” height= “480” q_r=“4” | /> |
| <Representation id=“A” bandwidth=“1536000” width=“1280” height= “720” q_r=“5” | /> |
| <Representation id=“B” bandwidth=“2048000” width=“1280” height= “720” q_r=“6” | /> |

<Representation id=“C” bandwidth=“1766000” width=“1920” height=“1080” q_r=“7”

| | |
|---|---|
| codec=“hvc1” | /> |

<Representation id=“D” bandwidth=“2048000” width=“1920” height=“1080” q_r=“8”

| | |
|---|---|
| codec=“hvc1” | /> |

<Representation id=“E” bandwidth=“3000000” width=“1920” height=“1080” q_r=“9”

| | |
|---|---|
| codec=“hvc1” | /> |

<Representation id=“F” bandwidth=“5000000” width=“3840” height=“2160” q_r=“10”

| | |
|---|---|
| codec=“hvc1” | /> |

</AdaptationSet>

As with the equivalent AVC data rate discussed above, the quality ranking attribute provides an ordering of the representations which is monotonic with respect to subjective quality. As before, this allows multiple criteria to be used by the streaming controller to select the appropriate representation from an adaptation set:

For an available link bandwidth of the HTTP link 150, the streaming controller 110 selects that representation which fulfills the following criteria:
the actual data rate of the representation is no higher than the available link bandwidth;
the quality ranking is indicative of as high a subjective quality as possible; and
the decoder 140 is capable of decoding video data of that format.

If the streaming controller 110 needs to change to a lower data rate representation (for example, because the HTTP link 150 is not able to cope with the current data rate, so that the buffer 142 is becoming unacceptably depleted) then the streaming controller 110 follows the same criteria and selects the next-lower actual data rate is defined by the MPD file for which:
the quality ranking is indicative of as high a subjective quality as possible; and
the decoder 140 is capable of decoding video data of that format.

Similarly, if the streaming controller 110 needs to change to a higher data rate representation (for example, because the HTTP link 150 is easily able to cope with the current data rate, so that the buffer 142 is becoming unacceptably full) then the streaming controller 110 follows the same criteria and selects the next-higher actual data rate is defined by the MPD file for which:
the quality ranking is indicative of as high a subjective quality as possible; and
the decoder 140 is capable of decoding video data of that format.

Note that in the examples given above, the quality ranking increases numerically with increasing subjective quality. However, the opposite sense could be used so that a smaller number indicates a higher subjective quality.

Note also that in some embodiments, even those representations with a very similar subjective quality may be given different quality rankings (or indeed, different equivalent data rates in the system of option 1) in order to avoid ambiguities in the selection algorithms carried out at the streaming controllers 110 of client devices. In some examples, this technique may be used so as to favour the lower data rate representation having a certain quality, by giving that representation and a higher “quality ranking” than a similar quality but higher data rate representation. Accordingly, in embodiments, for two versions of a similar encoding quality, the server data file defines that one of the two versions which has a lower data rate as having a higher quality than the other of the two versions.

A feature of using additional fields within the MPD file to define a quality ranking or an equivalent AVC data rate is that devices which respond to XML data of this nature will normally ignore any data fields which they do not recognise. So, the additional fields may be added without affecting the operation of legacy client devices not equipped to recognise the additional fields.

In some embodiments, the streaming controller 110 may be responsive to a user-defined bandwidth cap in respect of the HTTP link 150. In other words, the streaming controller 110 may be constrained not simply by the actual bandwidth of the HTTP link 150 but by the lower of (i) the instantaneous actual bandwidth of the HTTP link 150, and (ii) the user-defined bandwidth cap. This allows the user to avoid excessive data charges while still benefiting from a DASH adaptive system. Note that this arrangement could apply either to a basic DASH system as described earlier or to a system including equivalent data rates or quality rankings as later described.

FIG. 6 schematically illustrates a domestic media network in which a network interface 200 provides an Internet or other wide area network connection. A DASH streaming controller 210 provides DASH functionality to multiple devices, as described below. These devices include in this example a first television 220 (for example, a shared family television receiver), a second television 230 (for example, a bedroom television receiver) and a tablet computer 240. Other devices may be connected to the network. The devices are arranged to receive video data via a buffer arrangement 250 associated with the DASH streaming controller 210.

This embodiment addresses a problem which could occur in a network of adaptive streaming devices sharing a common connection to the Internet or another wide area network but using respective DASH adaptation. The potential problem is that all of the devices are competing for bandwidth, but the shared connection has a bandwidth limit. This can mean that the first device to be switched on expands its bandwidth usage (by normal operation of the DASH adaptation discussed earlier) so as to use a majority or nearly all of the available bandwidth provided by the network interface 200. This can in turn means that subsequent devices to be switched on, possibly including high priority devices such as the television 220, may be starved of bandwidth (which again will be handled by their respective DASH systems as discussed earlier). Another aspect of this potential problem is that any fluctuation in the bandwidth provided by the shared connection could lead to reactions by more than one of the separate DASH systems so that an excessive reaction might be prompted, which would then lead to a correction the other way and a possibly unstable control of the bandwidths required by each individual device.

To address this problem, a common DASH stream controller 210, responsive to the buffer arrangement 250 relating to each of the clients devices 220, 230, 240 . . . is provided. This controller 210 operates at a basic level according to the bandwidth control criteria:
the sum of the data rates of the representations selected for the client devices 220, 230, 240 . . . is no higher than the available link bandwidth provided by the network interface 200; and
the individual data rates of representations selected for each device are selected according to preset (such as user-set) proportions of the available bandwidth or, in the absence of such proportions, by a default of equal shares of the available bandwidth.
a preset minimum bandwidth per device can also be applied as a further criterion.

This arrangement can ensure that each device in the network of FIG. 6 is provided with a share of the available bandwidth of the shared network interface 200 which is fair (that is, either an equal share in a default situation or a fair share according to criteria set by the user responsible for the network), optionally subject to a preset minimum bandwidth per device, with the total data usage being no more than the capacity of the network interface 200.

In respect of the embodiments discussed above, in which a monotonic ranking of quality is provided even though subjective quality is not monotonically related to data rate, the further criteria set out below may also be applied in respect of each of the networked client devices:
the quality ranking is indicative of as high a subjective quality as possible, within the data rate allocated to that device; and
the decoder of that device is capable of decoding video data of that format.

The system described with reference to FIG. 6 may implement one or more of the following features:

In response to an instruction (for example, by the user operating a user control) to stream online content, the device (220, 230, 240 or similar) can be operable, possibly in collaboration with the controller 210, to detect the display format and/or range of data rates applicable to that content and inform the user as to how much data bandwidth (expressed, for example, in bits per second or as a percentage of the nominal or a current measurement of the total bandwidth available via the interface 200. In the case of adaptive streaming, the device (220, 230, 240 or similar) can inform the user a minimum and maximum data usage. The user can be allowed (via a user interface, for example) to set an upper (or indeed a lower) bandwidth or data rate limit or cap for that content which may be lower than the maximum data rate available under the adaptive scheme, so as to avoid excessive bandwidth usage. This can be particularly useful where the user is subject to a data quantity usage limit, for example per month, with either penalty charges or suspension of service being imposed by the user's internet service provider if the limit is exceeded. To assist the user in keeping track of how close he or she is to the monthly (or other) data limit, the present system can keep a record of data downloading and streaming activity (and, optionally, other activity) and inform the user if that data amount approaches the limit.

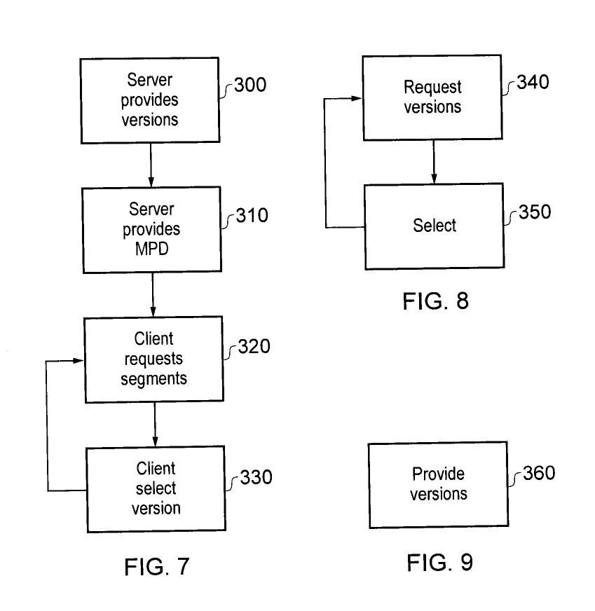

FIG. 7 is a schematic flowchart illustrating a media distribution method for a client device and a server device connected by a data link. The steps comprise:

at a step 300, the server device providing respective versions of successive contiguous segments of a media presentation, each segment being encoded as at least two versions at different respective data rates;

at a step 310, the server device providing a data file (such as an MPD file) to the client device defining the available versions of the segments according to their respective data rates and an indication of their respective encoding quality;

at a step 320, the client device requesting, from the server device, a version of each successive segment so as to stream the media presentation from the server device to the client device; and

at a step 330, in cooperation with the step 320, the client device selecting, in respect of a segment of the media presentation, a version having a data rate which does not exceed the data capacity of the data link and which has the highest indication of encoding quality.

FIG. 8 is a schematic flowchart illustrating a method of operation of a media distribution client device connectable to a server device by a data link to receive, from the server device, respective versions of successive contiguous segments of a media presentation, each segment being encoded as at least two versions at different respective data rates and a data file to the client device defining the available versions of the segments according to their respective data rates and an indication of their respective encoding quality. The method comprises:

at a step 340, requesting, from the server device, a version of each successive segment so as to stream the media presentation from the server device to the client device; and

at a step 350, in cooperation with the step 340, selecting, in respect of a segment of the media presentation, a version having a data rate which does not exceed the data capacity of the data link and which has the highest indication of encoding quality.

FIG. 9 is a schematic flowchart illustrating a method of operation of a media distribution server device connectable by a data link to a client device. The method comprises:

at a step 360, providing respective versions of successive contiguous segments of a media presentation, each segment being encoded as at least two versions at different respective data rates and a data file to the client device defining the available versions of the segments according to their respective data rates and an indication of their respective encoding quality.

The embodiments discussed above may be implemented in hardware, software (possibly including firmware), semi-programmable hardware (such as an application-specific integrated circuit or a field programmable gate array) or combinations of these. To the extent that software is used in the implementation of the embodiments, it will be appreciated that such software, and a storage medium by which such software is stored (for example, a machine-readable non-transitory storage medium such as a magnetic disk or an optical disc) are considered as embodiments of the present technology. In this regard, it will be appreciated that features of the embodiments discussed above such as the streaming controller 110, the media decoder 140 and the like may be implemented by general purpose processing units (CPUs) running appropriate software.

Respective aspects and features of embodiments of the present technology are defined by the following numbered clauses:
1. A media distribution system comprising a client device and a server device connected by a data link, in which the server device is configured to provide respective versions of successive contiguous segments of a media presentation, each segment being encoded as at least two versions at different respective data rates and the client device is configured to request, from the server device, a version of each successive segment so as to stream the media presentation from the server device to the client device;

the server device being configured to provide a data file to the client device defining the available versions of the segments according to their respective data rates and an indication of their respective encoding quality; and

the client device being configured to select, in respect of a segment of the media presentation, a version having a data rate which does not exceed the data capacity of the data link and which has the highest indication of encoding quality.
2. A system according to clause 1, in which, amongst the versions available in respect of a segment, the relationship between encoding quality and data rate is not monotonic.
3. A system according to clause 1 or clause 2, in which the client device comprises:

a data buffer configured to buffer media data received via the data link; and

a buffer occupancy detector configured to detect the occupancy of the data buffer;

the client device being configured to select a lower data rate version if the detected buffer occupancy falls below a lower occupancy limit.
4. A system according to any one of clauses 1 to 3, in which:

the versions are encoded according to a group of two or more different media encoders; and

the indication of the respective encoding quality comprises an indication of an equivalent data rate of a version if that version were encoded using a different media encoder of the group.
5. A system according to any one of the preceding clauses, in which, for two versions of a similar encoding quality, the server data file defines that one of the two versions which has a lower data rate as having a higher quality than the other of the two versions.
6. A system according to any one of the preceding clauses, in which the data file is a media presentation description file in an XML format.
7. A system according to any one of the preceding clauses, in which the server device is configured to supply the data file to the client device prior to the client device streaming the media data.
8. Media distribution server device connectable by a data link to client device, in which the server device is operable to provide respective versions of successive contiguous segments of a media presentation, each segment being encoded as at least two versions at different respective data rates and a data file to the client device defining the available versions of the segments according to their respective data rates and an indication of their respective encoding quality.
9. Media distribution client device connectable to server device by a data link to receive, from the server device, respective versions of successive contiguous segments of a media presentation, each segment being encoded as at least two versions at different respective data rates and a data file to the client device defining the available versions of the segments according to their respective data rates and an indication of their respective encoding quality;

the client device being configured to request, from the server device, a version of each successive segment so as to stream the media presentation from the server device to the client device, the client device being configured to select, in respect of a segment of the media presentation, a version having a data rate which does not exceed the data capacity of the data link and which has the highest indication of encoding quality.
10. A media distribution method for a client device and a server device connected by a data link, comprising:

the server device providing respective versions of successive contiguous segments of a media presentation, each segment being encoded as at least two versions at different respective data rates;

the server device providing a data file to the client device defining the available versions of the segments according to their respective data rates and an indication of their respective encoding quality;

the client device requesting, from the server device, a version of each successive segment so as to stream the media presentation from the server device to the client device; and

the client device selecting, in respect of a segment of the media presentation, a version having a data rate which does not exceed the data capacity of the data link and which has the highest indication of encoding quality.
11. A method of operation of a media distribution server device connectable by a data link to a client device, comprising:

providing respective versions of successive contiguous segments of a media presentation, each segment being encoded as at least two versions at different respective data rates and a data file to the client device defining the available versions of the segments according to their respective data rates and an indication of their respective encoding quality.
12. A method of operation of a media distribution client device connectable to a server device by a data link to receive, from the server device, respective versions of successive contiguous segments of a media presentation, each segment being encoded as at least two versions at different respective data rates and a data file to the client device defining the available versions of the segments according to their respective data rates and an indication of their respective encoding quality; comprising:

requesting, from the server device, a version of each successive segment so as to stream the media presentation from the server device to the client device; and

selecting, in respect of a segment of the media presentation, a version having a data rate which does not exceed the data capacity of the data link and which has the highest indication of encoding quality.
13. A non-transitory machine-readable storage medium on which is stored computer software which, when executed by a computer, causes the computer to perform the method of clause 10.
14. A non-transitory machine-readable storage medium on which is stored computer software which, when executed by a computer, causes the computer to perform the method of clause 11.
15. A non-transitory machine-readable storage medium on which is stored computer software which, when executed by a computer, causes the computer to perform the method of clause 12.
16. A data carrier on which is stored a data file defining available versions of segments of a media presentation stored at a media distribution server device according to their respective data rates and an indication of their respective encoding quality.
17. Computer software which, when executed by a computer, causes the computer to implement the method of any one of clauses 10 to 12.

It will be apparent that numerous modifications and variations of the present disclosure are possible in light of the above teachings. It is therefore to be understood that within the scope of the appended claims, the technology may be practiced otherwise than as specifically described herein.

The present application claims priority to United Kingdom Application 1305407.7 filed on 25 Mar. 2013, the contents of which being incorporated herein by reference in its entirety.

1. A media distribution system comprising client device circuitry and server device circuitry connected by a data link, in which the server device circuitry is configured to provide respective versions of successive contiguous segments of a media presentation, each segment being encoded as at least two versions at different respective data rates and the client device circuitry is configured to request, from the server device circuitry, a version of each successive segment so as to stream the media presentation from the server device circuitry to the client device circuitry;
the server device circuitry being configured to provide a data file to the client device circuitry defining the available versions of the segments according to their respective data rates and an indication of their respective encoding quality; and
the client device circuitry being configured to select, in respect of a segment of the media presentation, a version having a data rate which does not exceed the data capacity of the data link and which has the highest indication of encoding quality.

2. A system according to claim 1, in which, amongst the versions available in respect of a segment, the relationship between encoding quality and data rate is not monotonic.

3. A system according to claim 1, in which the client device circuitry comprises:
a data buffer circuitry configured to buffer media data received via the data link; and
a buffer occupancy detector circuitry configured to detect the occupancy of the data buffer circuitry;
the client device circuitry being configured to select a lower data rate version if the detected buffer occupancy falls below a lower occupancy limit.

4. A system according to claim 1, in which:
the versions are encoded according to a group of two or more different media encoders; and
the indication of the respective encoding quality comprises an indication of an equivalent data rate of a version if that version were encoded using a different media encoder of the group.

5. A system according to claim 1, in which, for two versions of a similar encoding quality, the server data file defines that one of the two versions which has a lower data rate as having a higher quality than the other of the two versions.

6. A system according to claim 1, in which the data file is a media presentation description file in an XML format.

7. A system according to claim 1, in which the server device circuitry is configured to supply the data file to the client device circuitry prior to the client device circuitry streaming the media data.

8. Media distribution server device circuitry connectable by a data link to client device circuitry, in which the server device circuitry is operable to provide respective versions of successive contiguous segments of a media presentation, each segment being encoded as at least two versions at different respective data rates and a data file to the client device circuitry defining the available versions of the segments according to their respective data rates and an indication of their respective encoding quality.

9. A media distribution method for a client device and a server device connected by a data link, comprising:
the server device providing respective versions of successive contiguous segments of a media presentation, each segment being encoded as at least two versions at different respective data rates;
the server device providing a data file to the client device defining the available versions of the segments according to their respective data rates and an indication of their respective encoding quality;
the client device requesting, from the server device, a version of each successive segment so as to stream the media presentation from the server device to the client device; and
the client device selecting, in respect of a segment of the media presentation, a version having a data rate which does not exceed the data capacity of the data link and which has the highest indication of encoding quality.

10. A non-transitory machine-readable storage medium on which is stored computer software which, when executed by a computer, causes the computer to perform the method of claim 9.
